(19) United States
(12) Patent Application Publication
(10) Pub. No.: US 2016/0090740 A1
(43) Pub. Date: Mar. 31, 2016

(54) MODULAR CONSTRUCTION SYSTEM

(71) Applicant: Mark Jeffery Giarritta, Foresthill, CA (US)

(72) Inventor: Mark Jeffery Giarritta, Foresthill, CA (US)

(21) Appl. No.: 14/962,698

(22) Filed: Dec. 8, 2015

Related U.S. Application Data
(62) Division of application No. 13/826,435, filed on Mar. 14, 2013.

(51) Int. Cl. E04C 1/39; B29C 39/04; E01C 5/06; E04B 1/04; E01C 5/00

(52) U.S. Cl. CPC E04C 1/39; E04B 1/043; E01C 5/006; E01C 5/06; B29C 39/04

(57) ABSTRACT

A module for a paving or building system can include a pan that provides one major surface of the module and a block that contains a cement mixture, attaches to the pan, and provides an opposite major surface with a cement finish. The pan may have side walls, and an upper portion of the concrete block can extend above a top edge of the pan. The block extending over the edge of the pan in a module allows for joining modules to create an extended cement finished surface. Passages may be provided though modules to allow assembly of modules using cables or bolts that extend through the passages of multiple modules.

### CROSS-REFERENCE TO RELATED APPLICATIONS

This patent document is a divisional and claims benefit of the earlier filing date of U.S. pat. app. Ser. No. 13/826,435, filed Mar. 14, 2013, which is hereby incorporated by reference in its entirety.

### BACKGROUND

Conventional concrete paving for sidewalks, driveways, and roads normally requires building forms with or without reinforcing structures at the site to be paved, pouring of concrete into the forms, and working and finishing the concrete at the site. Different sites may be subject to variable conditions such as the composition or moisture content of the underlying soil or base and weather conditions such as temperature and humidity at the time the concrete is poured. Some weather conditions such as precipitation or temperature may make pouring of concrete infeasible. Even when concrete can be poured, differences in site conditions can cause concrete to cure differently and provide differences in the strength or other qualities of the concrete. As a result, concrete poured on site must be sufficiently thick to provide the necessary strength, e.g., to be able to withstand the weight of an automobile, even in the worst case scenarios for the site.

Pavers have been used for lower load situations. Pavers may be fabricated at a manufacturing facility, which may avoid many of the problems of variable site conditions. However, pavers are generally small and made out of lighter weight materials such as clay or resin to facilitate transportation to an installation site. The lighter weight materials are generally weaker or more expensive than concrete. Even when pavers contain limestone-based cement, e.g., Portland cement, aggregate such as crushed rock is avoided in the paver materials to reduce the weight of the pavers. Such cement mixtures without aggregate are generally weaker than the mixtures used in concrete driveways or roadways. The discrete or separate nature of pavers can also present complications when a large area needs to be paved and act as a single slab. As a result, conventional pavers have drawbacks where large or load bearing structures are desired.

### SUMMARY

In accordance with an aspect of the invention, a module for a paving or building system can include a pan and a concrete block having a lower portion in the pan. An upper portion of the concrete block can extend above a top edge of the pan. The concrete extending over the edge of the pan in a module allow for joining modules to create an extended surface with tight concrete-to-concrete joints.

One specific implementation is a module including a pan having a bottom and a concrete block attached to and overlying the pan.

Another specific implementation is a structure including multiple modules. Each module includes a first pan having a bottom, a concrete block attached to and overlying the pan, and a passage through the module. The passage in at least one of the module and parallel to the bottom of the pan. The structure further includes an attachment structure that extends through the passages of multiple modules and holds the modules together.

Yet another specific implementation of a method for fabricating a concrete module. The method includes: abutting forms adjacent to edges of a pan; pouring concrete into volume defined by the pan and the forms; and removing the forms to create a transportable module in which the pan is integrated.

### BRIEF DESCRIPTION OF THE DRAWINGS

FIG. 1A shows a perspective view of one implementation of a system for fabrication of concrete modules.

FIG. 1B shows a cross-sectional view of the system of FIG. 1A after forms have been attached to a pan and concrete has been poured into the assembled mold.

FIG. 1C shows a cross-sectional view of one implementation of a concrete module fabricated using the system of FIG. 1A.

FIG. 2A shows a perspective view of a system for fabrication of concrete modules that employs through bolts for attachment of forms and for interconnecting concrete modules.

FIG. 2B shows a perspective view of a system for fabrication of concrete modules that employs a pan lacking side walls.

FIG. 3A shows a cross-sectional view of concrete modules connected together using thread connectors having male and female ends.

FIG. 3B shows a plan view of concrete modules connected together using thread connectors.

FIGS. 4A and 4B show plan views of slabs or paved areas created using multiple concrete modules interconnected using post tensioning.

FIG. 5A shows a cross-sectional view of a concrete module having a convex side and a concave side.

FIG. 5B illustrates a tilt down technique for placement of a concrete module with a concave side adjacent to a concrete module having a convex side.

FIG. 5C illustrates the placement and connection of modules on a surface having a change in slope.

FIG. 6A shows a cross-sectional view of a concrete module having sides at a non-perpendicular angle to the top and bottom of the concrete module.

FIGS. 6B and 6C illustrate connection of modules according to FIG. 6A respectively on a straight area and an area including a change of slope.

FIG. 7 illustrates one implementation using concrete modules to construct a curb or gutter.

FIG. 8 illustrates one implementation using concrete modules to construct stairs.

FIG. 9 illustrates one implementation using concrete modules to construct a structure such as a portion of a building.

FIG. 10 illustrates one implementation of a module in which a concrete block may be encased within covers both major surfaces of the block.

The drawings illustrate examples for the purpose of explanation and are not of the invention itself. Use of the same reference symbols in different figures indicates similar or identical items.

### DETAILED DESCRIPTION

A construction system can employ modules including a concrete block with an integrated pan. The modules may particularly employ a standard concrete mix of cement, aggregates and a manufactured sand made of crushed stone. Accordingly, the modules are not limited to mixes without aggregate, which may be used in precast manufacture. The added strength of a standard concrete mix compared to a non-aggregate mix combined with the added tensile strength of the integrated pan allows use of thinner concrete for a job, for example, a concrete two inches thick for a driveway supporting an automobile, and the reduction in thickness can compensate for the use of dense, strength-adding aggregate to reduce weight. The weight reduction allows transporting of modules and reduces fabrication costs. Further using a standard concrete allows production of modules with a finished slab or visible wall surface with any standard and custom concrete finishes such as but not limited to: broomed finished, burned or smooth finished, exposed aggregate, rock salt, stamped concrete of all textures, integral coloring, color hardeners, powdered antiquing release, liquid color, acid stain and liquid stains, using the same proven finishing techniques used today in all phases of concrete. Further, module manufacturing parameters may allow same day manufacture delivery in some cases. Further, the product delivered may be a fully cured finished product that can be driven or built on immediately, which may reduce customer's overall wait time. Accordingly, use of modules may save both time and money when compared to conventional on-site concrete work.

In addition to interior and exterior residential flat work such as driveways, sidewalks, patios, paver stones, stepping stones, counters, fireplace mantles and surrounds, homes, foundations, and piers, some modules implemented as described herein can be applied to sidewalk curb and gutter, handicap ramps, pool decks, shower stalls, garbage stalls, roadways, K rail, median dividers, freeways, commercial foundations, commercial buildings, light standards, parking bollards, precast benches and furniture, floating docks, parking lots, parking structures, structural beams and components, roofing, roofing tiles, high rises, bridges, tunnels, underground structures, dams, monuments, doors and all other phases of concrete. Various implementations of the module might be employed for any and all particular phase of concrete construction.

The pan of a module can form all or part of a mold that defines the shape of the concrete during manufacture of the module and can remain part of the module to provide the module with greater structural strength. The pan can further provide or include connecting features that enable connection of multiple modules in an array or a more complicated structure. Further, a module may include a tube, through-hole, or slot to accommodate connecting bolts or a tensioning system that can pass through and join multiple modules in an extended structure. Such connection techniques may make structures that are resistant to natural disasters, sinking, or heaving even in areas with unstable soil. In one implementation, modules can be connected with cables. In another implementation, modules can be connected together using bolts, threaded stock, or other connectors that fit within tubes, through-holes, or slots provided in the concrete modules. Systems assembled using concrete modules may further provide flexibility that permits disassembly and reassembly if sinking or other changes occur after installation or reuse elsewhere if paving needs change.

In one specific embodiment, the concrete portion of a module can include reinforcing materials, e.g., fiber mesh reinforcement, that may be free floating or affixed to the pan of the module and the pan may include posts or projections that improve adhesion of the pan to the concrete. Concrete modules can be fabricated in a controlled environment such as a factory where conditions can be optimized for the strength of the concrete. Batching of concrete on site and pouring directly from a mixer to a form can avoid variations in mixing time that may be associated with ready-mix deliveries of concrete to locations at different distances from concrete suppliers. For example, by batching concrete in a mixer with a steady reduced temperature directly to forms, an accelerated cure that ready mix travel may induce, can be avoided. Further reducing temperature, e.g., below about 50 degrees, in a pour area for the duration of a pour, not only extends cure time tremendously but also may greatly extend finishing time to allow a concrete finisher to finish more, e.g., two to four times, area of concrete per pour and may also make finishing easier because duration of ideal concrete conditions for finishing may be extended. Further, storing the newly finished product at reduced temperature but above 32 degrees, may extend the overall cure time but significantly increase the strength of the cured concrete. Thus, a concrete mix that may only be rated at 2500 psi when installed with conventional on site techniques may test out between 4000 and 5000 psi when produced under controlled manufacturing conditions. The consistency and quality of the concrete and the increase in strength that the integrated pan provides to a module can reliably produce concrete modules with strength much greater than conventional on-site poured concrete. As a result, concrete structures created with modules disclosed herein may have a much smaller minimum thickness of concrete or may be stronger than conventional concrete structures of the same weight.

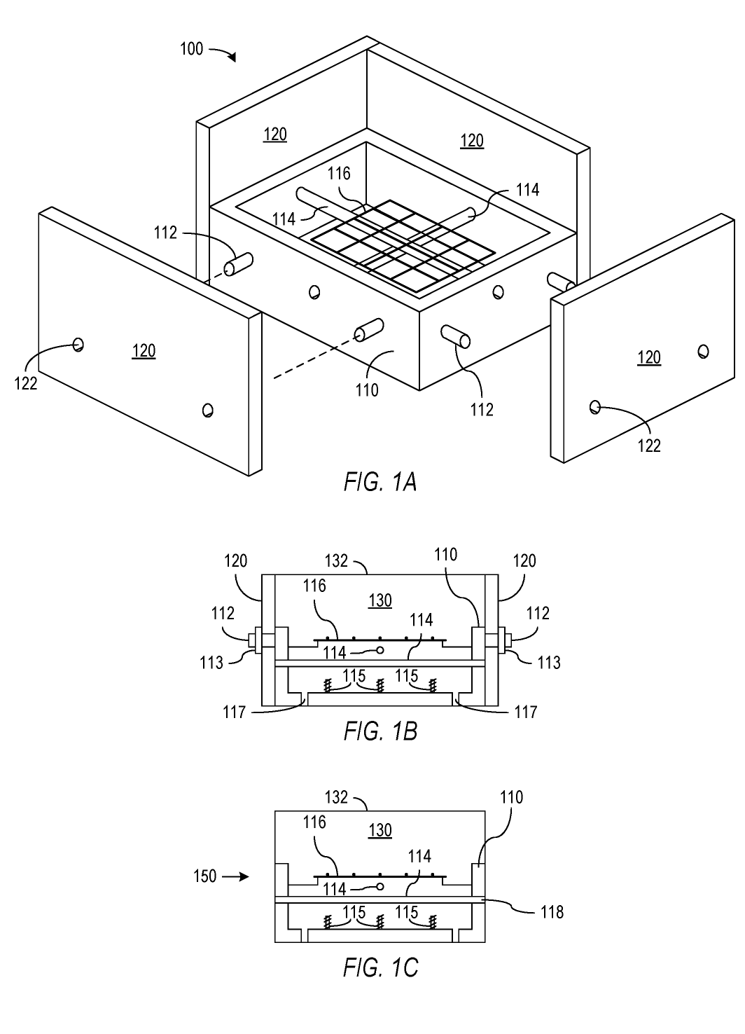

FIG. 1A illustrates a system 100 for fabrication of a concrete module 150 in accordance with one embodiment of the invention shown in FIG. 1C. System 100 includes a pan 110 that remains an integrated part of concrete module 150 and may be below or may contain at least a lower portion of a concrete slab or block 130 that is part of the concrete module as shown in FIG. 1B or 1C. Pan 110 can be fabricated using a variety of materials, not limited to wood, plastic, resin, stone, and metal. For example, steel or other metal in sheet or bulk form may be bent or cast to create pan 110. Making pan 110 out of metal may provide a strong structure and may also permit welding, brazing, soldering, or inclusion of male or female threaded features that can attach structures such as threaded assemblies 112, post tensioning tubes 114, anchors or adhesion posts 115, or concrete reinforcing materials 116 to pan 110 in some implementations of system 100. Holes 117 to provide drainage and control moisture during curing of concrete may also be drilled or punched through a metal pan. In an alternative implementation, pan 110 may be a lighter material such as fiberglass, plastic, or resin that provides a desired shape and may provide a lighter weight concrete module 150. Material such as fiberglass, plastic, or resin may also provide a moisture barrier with a long life when the bottom of pan 110 is in contact with soil. In one specific implementation, pan 110 is primarily a light material such as plastic but includes a reinforcing metal band that may include threaded holes for attachment of threaded assemblies 112.

In the illustrated implementation, pan 110 is rectangular, which defines an area of concrete module 150. More generally, pan 110 could have any shape. For example, instead of being rectangular or square, pan 110 may be triangular, trapezoidal, hexagonal, wedge shaped, round, ink-blot shaped, or define any shape areas for concrete modules 150. In one implementation, the shape of pan 110 is selected for use with other similar or different modules to cover an extended area using a tiling pattern. Further, pan 110 in the illustrated implementation has a flat bottom and four straight sides that are perpendicular to the bottom of pan 110. More generally, the bottom and side walls of pan 110 are not required to be flat or perpendicular but may be angled or curved along vertical or horizontal directions and the sidewalls may be omitted altogether. Additionally, the sides of pan 110 or bock 150 may include alignment features such as projections or complementary slots, arranged so that a projection on one module 150 can engage a slot on another module to align the modules for connecting bolts or cables.

The bottom of pan 110 may further include anchors, projections, or posts 115 to anchor or otherwise improve adhesion of pan 110 to block 130 in the finished module 150 and holes to provide drainage and control moisture during pouring and curing of concrete. For example, pan 110 may include posts 115 that are spaced about two to four inches apart across the area of pan 110. Adhesion posts 115 may be shaped to increase adhesion of pan 110 to block 130 and/or increase resistance that prevents pan 110 from pulling away from block 130. Adhesion of pan 110 to block 130 allows module 150 to act as an integrated unit with greater tensile strength that block 130 would have alone. In the embodiment of FIGS. 1B and 1C, adhesion posts 115 has a helical or screw-shaped features that resist pan 110 separating or pulling away from block 130. Alternatively, adhesion posts 115 could have many other shapes including but not limited to a cork screw shape, a zigzag shape, a T-shape, or a mushroom-shape. Holes 117 may be about one eighth to one quarter inch in diameter and may be fewer than post 115. For example, a pan 110 that is two feet by two feet may include fifteen to twenty holes 117.

The size of pan and the height of forms 120 can also be selected according to the use of module 150. For example, for a driveway that must withstand the weight of automobiles or other vehicles, pan 110 when rectangular may be as small as a few inches on each side, more typically about two feet by two feet, or larger. In regard to height, pan 110 may have a wall height ranging from zero, i.e., no walls, up to the full thickness desired for the concrete thickness. The height of forms 120, which may control the concrete thickness of module 150, may in a typical implementation for paving be one to two inches thick but otherwise can be any desired height depending on the application of the concrete module. This is the minimum for a slab application, and module thickness can vary to a much greater thickness depending on application and especially in but not limited to a foundation footing, bridge, high rise, tunnel, freeway overpass, roadway, or freeway type application.

A method for manufacturing a concrete module 150 may include attaching side forms 120 to pan 110. In the illustrated implementation, threaded posts 112 that are attached to pan 110 and fit through matching holes 122 in side forms 120, and forms 120 may be temporarily affixed to pan 110 using nuts 113 threaded onto posts 112. Alternatively, other attachment mechanisms could be employed with or without using posts 112. For example, instead of being threaded, posts 112 may be shaped to engage a quick release mechanism that presses forms 120 to respective sides of pan 110. Another option for holding forms 120 in place is bolts or screws that pass through forms 120 and thread into pan 110. Alternatively, posts 112 could be omitted, and clamps or bands (not shown) outside of forms 120 could be used to hold forms 120 in place against the sides of pan 110. In yet another implementation, bolts, cables, or other structures that are temporarily attached to pan 110, wrapped around the outside of forms 120, or inserted through tubes 114 can hold forms 120 in place during fabrication of a module 150. In still another implementation, a machine (not shown) can move forms 120 using hydraulic pistons or other actuators to press forms 120 against the sides of pan 110 for pouring of concrete and move forms 120 away from pan 110 once the concrete is sufficiently cured.

FIG. 1B further shows that with forms 120 in place a cement mixture such as concrete in a block 130 can be poured into a volume defined by pan 110 and forms 120. Cement as used here means limestone-based cement, e.g., Portland cement, mixed with other materials, and in one specific implementation, the cement mixture is concrete, which includes cement, sand, and aggregate. The pouring of block 130 can be performed in a controlled environment to provide high-strength concrete in block 130. A variety of different concrete mixtures could be employed. For example, a standard concrete “5 sac” mix can be made with a 1-2-3 ratio, one part cement, two parts sand, and three parts gravel. The mix may be made stronger by adding more cement or fly ash or fiber mesh reinforcement. As used herein, sand and gravel are not limited to natural stone but could be other particulate materials including but not limited to any metals, crystals, diamond, artificially made stones, glass or any non-biodegradable material. The cement used can be of any origins or molecular make up in current use or conceived in the future. The mixtures may further incorporate additives for various purposes such as accelerating drying, retarding drying, water reduction, plasticization or consolidation and coloring or to increase coloration of end product. Epoxy's may also be added to strengthen the concrete and for the purpose of adhesion mainly in overlays. Although use of aggregate may provide advantages to modules described herein, mixes without aggregate and/or sand may be employed in some implementations, and any conceivable mix design in current practice or to be used or discovered in the future might be employed. For example, regardless of the mix, concrete, mortar or overlay, pan 110 may increase the strength of a module containing any mix. However, a standard mix such as described here may be best for a combination of strength and cost.

In accordance with one implementation, block 130 includes aggregate, e.g., standard crushed rock having a size greater than or equal to about one quarter to one half inch or more. The mixing time of the concrete before pouring can be tightly controlled to optimize the strength and reliability of block 130. Further, pan 110 with holes 117 controls moisture loss through the bottom surface of block 130 and therefore removes one of the variable conditions often present in on-site concrete pours. Employing aggregate in a transportable concrete module such as module 150 is particularly practical in the illustrated implementation because pan 110 and controlled manufacturing processes can provide module 150 with exceptional strength, which permits making module 150 thinner than an on-site poured slab of equivalent strength. Accordingly, modules 150 can be transportable even when a heavy aggregate is used in concrete block 130.

FIGS. 1A, 1B, and 1C show tubes 114 and reinforcing structure 116 will be encased in block 130. Reinforcing structure 116 can include rebar, wire mesh, fiber mesh, or other extended structures and that may be attached to pan 110. Although FIG. 1B shows reinforcing structure 116 above tubes 114, reinforcing structures 116 could be above, below, or around tubes 114, could extend above the top edge of pan 110, or could be omitted. Tubes 114 may be plastic pipe or similar structures used to define a bore or passage 118 through module 150, so that a cable, rod, bolt, or other structure can be inserted through passage 118 for connecting multiple modules together during installation as described further below. If tubes 114, which define passages 118, are hollow, e.g., pipes, tubes 114 may remain part of the finished module 150 or may be removed to leave post tensioning passages 118 through concrete block 130. In one specific implementation, passages 118 may be defined by tubing, e.g., PVC pipe, that is one eighth inch or larger and extends through pan 110 and module 150 leaving openings in the sides of pan 110 and the finished module 150 and tubes 114 remain part of finished module 150.

Tubes 114 and passage 118 as described further below may be employed facilitate connection of multiple modules 150 into a larger structure. Tubes 114 and passages 118 may be omitted in some implementations of modules 150. For example, a module 150 use for a standalone application such as for individual stepping stones may not need to be connected to other modules and does not require tubes 114 or passages 118. Alternative joining techniques could also be employed to joint multiple modules without need of tubes 114 or passages 118. For example, drilling holes and inserting connectors can add connectors to a module 150 after casting, so that tubes 114 and passages 118 are not required.

Forms 120 permit block 130 to be thicker than the depth of pan 110. For example, pan 100 may have a depth of about zero to two inches, while forms 120 extend about zero to two inches above pan 110, in which case block 130 may be between one and four inches thick. Additionally, a portion of block 130 may be above edges of pan 110, so that a top surface 132 of module 150 has a cement finish that extends from edge to edge of the top surface of module 150. For example, if pan 110 has walls of a light weight material such as plastic or resin, the walls of pan 110 may be relatively thick, e.g., up to one eighth inch or more thick, but since block 130 extends above the walls of pan 110, module 150 may abut another module and provide a top surface with a concrete to concrete seam without showing any of the top edge of pan 110.

Top surface 132 of concrete block 130 poured into the mold create by pan 110 and forms 120 can be finished to produce any desired surface finish including but not limited to a smooth, brushed, or stamped concrete surface. Additionally, although such finished surfaces are sometimes referred to herein as cement finishes or surfaces, cement finishes herein are intended to include surfaces that may have coatings such as sealers over cement mixtures and also thicker coatings of materials such as resins or other paving materials on cement mixtures. Once block 130 has sufficiently hardened or cured forms 120 can be removed and reused in the fabrication of another module 150. FIG. 1C shows a final concrete module 150 in an implementation in which threaded posts 112 are removed from pan 110 or were not used to hold forms 120 in place during module manufacture. Alternatively, posts 112 could remain part of module 150 and be used to align, join, or attach modules to each other.

The dimensions of module 150 of FIG. 1A, 1B, and 1C may vary widely according to use of module 150. However, module 150 is not drawn to scale for a typical use. In particular, for a driveway application, module 150 might be two feet by two feet but only two inches thick and thus would be thinner than shown in FIGS. 1A, 1B, and 1C. In even thinner applications, concrete block 130 may be one eighth to one inch thick, and be more of an overlay in which pan 110 provides much of the strength of the finished module, and passages 116 may be omitted if necessary. An overlay module can provide upper surface 132 with a desired cement finish for decorative applications, e.g., flooring, siding, or wall covering, without requiring the weight of traditional concrete or cement structures.

Module 150 in the illustrated embodiment contains tubes 114 or passages 118 for interconnection of multiple modules as described further below, but modules could also contain other structures. For example, tubes 114, passages 118, or other tubing (not shown) could be use for hydronics. For example, plastic tubing that runs through the concrete mass of block 130 can carry heated water that is pumped through module 150 to heat the mass create warm floors and provide radiant heating. The hydronics could be positioned to interconnect with hydronics in other modules when modules are connected to cover a wide area. Such heating could be used for indoor heating or outdoors, for example, to keep the concrete warm enough to stop ice or snow from being able to form up heated areas. Similarly, built in heating blankets could be incorporated in modules 150 for the same heating purposes, and the electric heating blankets could have a cast plugs for interconnection if all heating blankets into one electrical circuit. Module 150 could additionally contain insulating material with or without including hydronics or heating blankets.

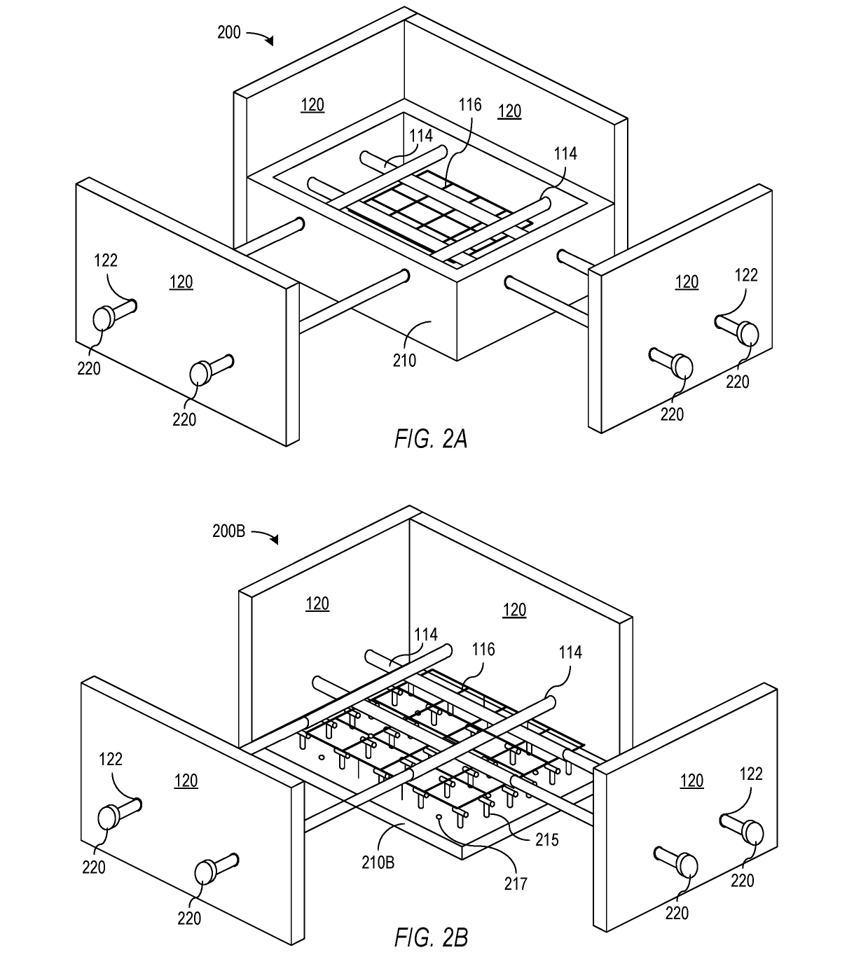

System 100 of FIG. 1A may be altered in a variety of ways in different implementations. FIG. 2A, for example, shows a system 200 employing a pan 210 that uses threaded stock or bolts 220 that extend through passages 118 to hold forms 120 in place. In the implementation of FIG. 2A, threaded stock or bolts 220 can be inserted through respective holes 122 in forms 120 and respective tubes 114 that define passages 118. For example, bolts 220 may be longer than tubes 114 so that each bolt 220 extends through a hole 122 in one form 120, a guide passage 118, and a hole 122 in the opposite form 120, so that two opposite forms 120 can be held in place adjacent to pan 110 using bolts 220 and nuts (not shown) on the far ends of bolts 220. In some implementations, other types of connectors can be inserted through tubes 114 or tubes 114 can be threaded, so that bolts shorter than bolts 220 can attach individual forms 120 to pan 110. In still other alternative implementations, guide tubes 114 can be omitted. In particular, bolts 220 or other form connecting structures can extend through pan 210 during pouring of concrete and can be removed after curing of the concrete to leave passages 118 in the concrete block 130 of the completed module 150. Even thought bolts 220 may be able to hold tubes 114 in position for pouring of a cement mixture such as concrete, connecting structures, e.g., uprights, that connect pan 210B to tubes 114 and to reinforcement 116 may be desirable to increase the strength or rigidity of the finished module 150.

FIG. 2B shows yet another implementation of a system 200B for manufacture of a concrete module. System 200B differs from system 200 of FIG. 2A in that a pan 210B of system 200B includes a bottom without walls. Tubes 114 are thus not held in place by pan 210B, but bolts 220 through forms 120 can hold tubes 114 in position around the edge or perimeter of pan 210B during pouring of concrete. The lack of side walls on pan 210B in the view of FIG. 2B exposes projections or posts 215 that extend up from the bottom of pan 210B and holes 217 through the bottom of pan 210B. FIG. 2B illustrates an implementation in which posts 215 are T-shaped, but many other shapes could improve the attachment strength of pan 210B to an concrete block to be formed on and overlying pan 210B. In the finished module, concrete surrounds posts 215 so that pan 210B may strongly adhere to the concrete. Similar posts can also be included in pans having walls as illustrated in FIGS. 1B, 1C, and 2A.

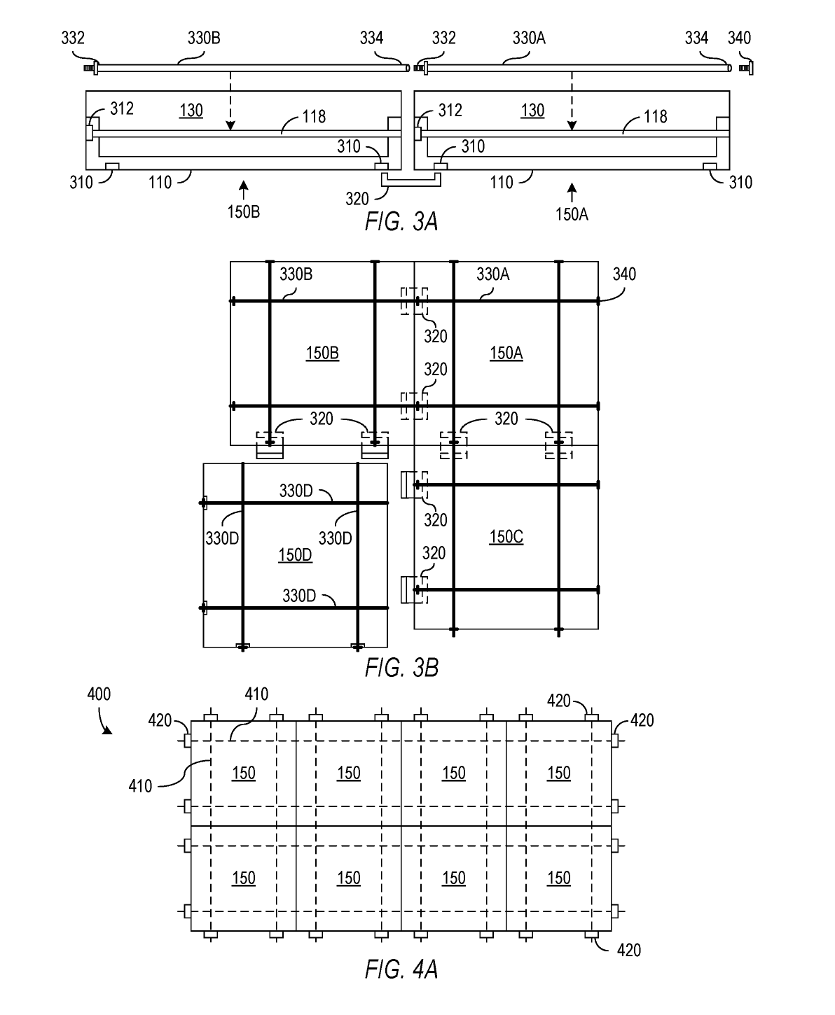

FIG. 3A illustrates a system for interconnecting concrete modules 150A and 150B. Each module 150A and 150B may be substantially identical to module 150 described above. In the implementation of FIG. 3A, pans 110 of modules 150A and 150B each include bottom features 310 capable of engaging joiners 320. In the illustrated implementation, bottom features 310 are slots into which tabs on joiner 320 fit. During a process of installing modules 150A and 150B, one or more joiner 320 can be placed the ground under module 150A so that tabs on joiners 320 fit respectively within slots 310 in pan 110 of module 150A. Notch features 310 can be larger than the tabs on joiners 320 to provide play for positioning of modules 150A and 150B, particularly where a change in grade may bend or tilt joiner 320. With module 150A in place, threaded connecting rods 330A can be inserted through the passages 118 in module 150A.

Module 150A for illustration of an installation process will be assumed to be a corner or edge module of an array of modules 150 that are connected together using connecting rods. In the illustrated embodiment, each connecting rod 330A has a male-threaded end 332 and a female-threaded end 334. In an alternative configuration, end 332 may have female threading, and end 334 may have male threading. End 332 further has a flared portion similar to the head of a bolt and a rod or a tube-like projection extending from the flared portion of end 332 to end 334. Connecting rod 330A can be inserted end 334 first through passage 114, until the flared portion or end 332 rests against pan 110. In one configuration, pan 110 or concrete block 130 of module 150A has a recess or notch 312 sized so that when connecting rod 330A is fully inserted end 332 does not extend beyond the edge of module 150A to which module 150B will be abutted. Otherwise, end 332 may extend beyond the edge of module 150A. With connecting rod 330A fully inserted in passage 114, a bolt or nut 340 with threading that matches end 332 can be tightened onto end 334 at an opening of passage 118 at an edge of module 150A to which no module will be attached. Tightening bolt or nut 340 on connecting rod 330A fixes connecting rod 330 in passage 118.

Module 150B can then be positioned with an edge abutting module 150A. Connecting rods 330B, which may be identical to or slightly longer than connecting rods 330A, can be inserted through passages 118 in module 150B so that the end 334 of connecting rod 330B can be threaded onto or into the end 332 of connecting rod 330A. To assist in the tightening process, end 332 may additionally include a slot, e.g., a hex key slot, on male threading or a perimeter, e.g., a hex or square head, around female threading, so that a socket or other tool that tightens connecting rod 330B onto connecting rod 330A can engage end 332 without damaging the threads on end 332 of connecting rod 330B. Many other existing or yet to be developed tools could be employed for twisting bolts 330 together and may be employed in alternative implementations. Connecting rod 330B may start with end 334 flush or recessed relative to an edge of module 150B, but the tightening process may draw connecting rod 330B further through passage 114 in module 150B and draw end 334 into recess 312 of module 150A, particularly in an implementation where end 332 resides within recess 312 in pan 310.

A rectangular array of modules 150 can be assembled by sequentially joining modules in an order such that no module 150 being joined abuts more than two other modules. FIG. 3B, for example, illustrates an example in which module 150B is joined to module 150A as described above. A module 150C can then be joined to module 150A in the same fashion without interference from module 150B. A module 150D would then need to join both modules 150B and 150C. Module 150D may be initially aligned or placed in the array using alignment features such as alignment dowels into complementary slots that may be formed in the sides of modules 150. The initial alignment may roughly align passages in module 150D with passages in modules 150B and 150C. Since ends 332 of connecting rods 330 passing through modules 150B and 150C toward module 150D do not significantly protrude beyond the edges of modules 150B and 150C, module 150D can be simultaneously abutted to both modules 150B and 150C, and connecting rods 330D inserted through the passages in module 150D can be threaded onto connecting rods in module 150B and 150C.

FIG. 4A shows a plan view of multiple concrete modules 150 that may be connected together using tensioning cables, rods, or similar extended structures 410. To illustrate one definite example, the following considers the case in which extended structures 410 are cables, e.g., stranded or woven steel cable, but other types of extended structures could be employed in alternative implementations. In FIG. 4A, modules 150 are arranged in a rectangular array and each cable 410 is threaded through passages in multiple modules. More specifically, each module 150 in the array includes at least one passage 118 that is aligned with passages in each of the other modules 150 in the same row of the array, so that a cable 410 can pass through all of the modules in the row. Similarly, each module 150 in the array includes at least one passage 118 that is aligned with passages 118 of the other modules 150 in the same column of the array, so that a cable 410 can pass through all of modules 150 in the same column. The ends of cables 410 can be attached to structures 420. Each structure 420 may be a fixed structure such as a portion of a foundation, stem wall, stair, existing slab, sidewalk curb and gutter, large stone, or retaining wall that may rest against end modules 150 and hold or apply tension in a cable 410 through a row or column of modules 150. Alternatively, a structure 420 may only be fixed in that it presses against a side of one of modules 150 and holds or applies tension to a cable 410 passing through that module. If desired, the sides of modules 150 may have a shape or feature that interlocks with a complementary shape or feature on the adjacent module 150, so that the tension prevents modules 150 from separating and the interlocking shapes or features prevent modules 150 from sliding relative to each other. Such interlocking features may be part of the pans 110 of modules 150 or may be formed in the concrete portions of modules 150.

Connecting modules 150 using post tensioning technology is not limited to rectangular arrays or module 150 having rectangular areas. FIG. 4B illustrates an implementation in which a slab 490 may be constructed using trapezoidal 430, 440, and 450 and rectangular modules 460. Trapezoidal modules 430, 440, and 450 have opposite sides that diverge at a given angle, and in the implementation of the divergence angles of trapezoidal modules 430, 440, and 450 are all the same. Each module 430, 440, or 450 has shorter and longer edges that are parallel and may be straight, arched, or some other shape. Modules 430, 440, and 450 may be sized so that the longer of the parallel edges of each module 430 is about the same size as the shorter of the parallel edges of each module 440, and the longer parallel edge of each module 440 is about the same size as the shorter parallel edge of each module 450. With trapezoidal module 430, 440, and 450, slab 490 can have edges that are curved or otherwise provide a feature that is not straight and varies over a distance larger than the size of any individual module 430, 440, 450, or 460. In the implementation of FIG. 4B, each cable 410 be inserted through a series of modules, e.g., three modules 460, three modules 430, 440, and 450, five modules 430 sandwiched between modules 460, five modules 440 sandwiched between modules 460, or five modules 450 sandwiched between modules 460. Slab 490 is just one simple example of a layout for modules connected using post tensioning technology, and other implementations could employ more or fewer columns and rows and more or fewer types of modules.

Modules 430, 440, 450, and 460 of FIG. 4B may alternatively be joined using rods or bolts such as described with reference to FIGS. 3A and 3B. However, threaded bolts may require swivels or universal joints when passages 118 in abutted modules 150 are not parallel, i.e., are at a non-zero angle as are the aligned passages in two adjacent trapezoidal modules of the same type 430, 440, or 450.

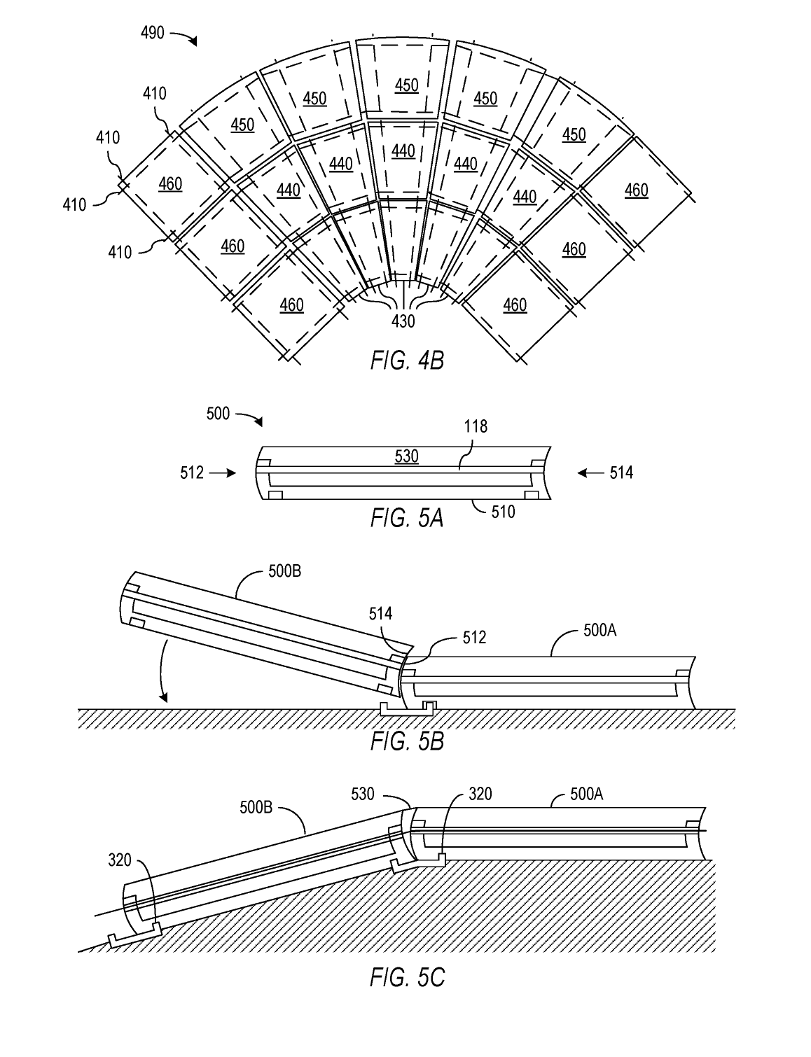

FIG. 5A illustrates an implementation of a concrete module 500 having a convex edge 512 opposite a concave edge 514. In one specific implementation, each edge 512 and 514 has a cylindrical shape. The other two ends of module 500 may be flat, and the construction of concrete module 500 may be otherwise the same as module 150 described above. In particular, module 500 includes an integrated pan 510, and in one implementation of pan 510, a concrete block 530 extends above the bottom of pan 510 and possibly above the walls of pan 510. Pan 510 and concrete block 530 may be identical to pan 110 and concrete block 130 described above with the exception that sides 512 and 514 are curved. To provide curved sides 510 and 520, pan 510 for module 500 has curved sides, and reusable forms (not shown) that may be abutted to those sides during pouring and finishing of concrete block 530 may similarly be curved.

FIG. 5B illustrates how curved sides 512 and 514 may assist in positioning of a module 500B. In particular, when adding block 500B to a structure including block 500A, a curved side 512 of a module 500B may be abutted to a complementary curved side 514 of module 500A while the opposite side of module 500B is tilted up. Accordingly, a portion of the weight of module 500B may be borne by module 500A while module 500B is being aligned. Once the alignment is adjusted, module 500B can be tilted down into place and cables, bolts, or other attachment structures can later attach module 500B to module 500A.

Curved edges 510 and 520 or flat perpendicular edges can abut each other without significant gap on a flat surface, i.e., on a surface without a change of slope or grade. However, edges that fit together on a flat surface without creating a gap may have a gap when abutted on an area with a change of slope. FIG. 5C illustrates an example in which modules 500A and 500B are at an angle to each other. The change in slope creates a gap 530 between modules 500A and 500B even when the edges of modules 500A and 500B touch. Gap 530 can be filled, for example, with a cement based material such as grout or some other adhesive or filler material such as resin or epoxy. FIG. 5C also illustrates how a joiner 320 that engages bottom sides of modules 500A and 500B may need to bend when modules 500A and 500B are at different slopes. Accordingly, joiner 320 may be made of a flexible material such as plastic to accommodate changes in the slope between modules.

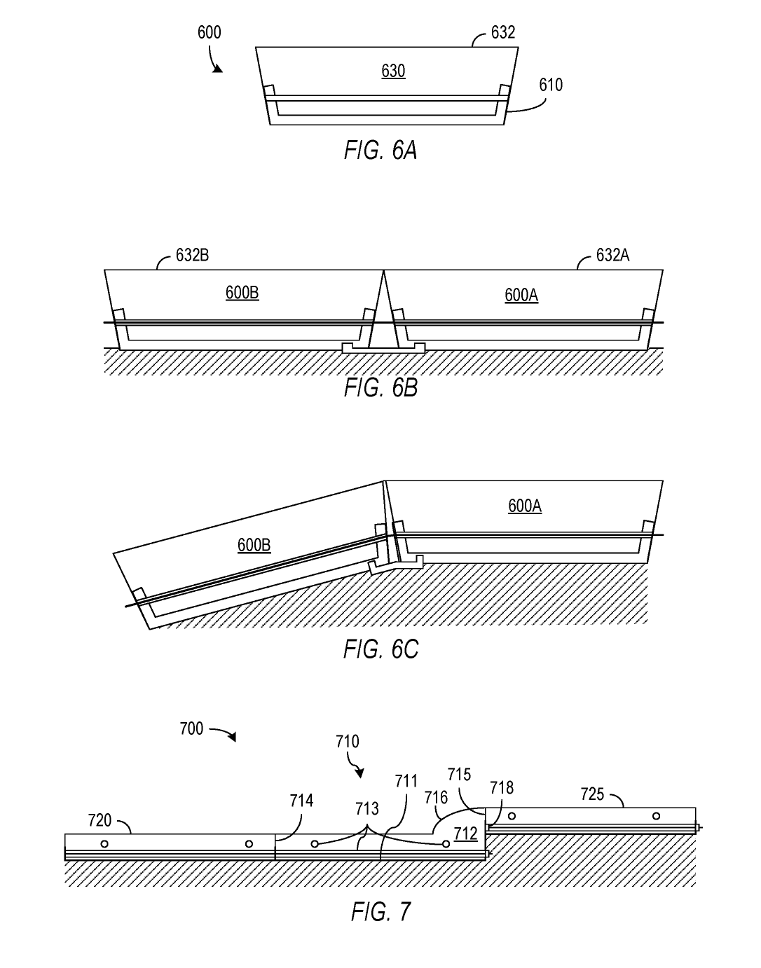

A module with sides that are angled relative to its base can reduce or avoid surface gaps that sometime occur at a change in slope. FIG. 6A, for example, illustrates a module 600 with angled sides. In particular, a finished-concrete, top surface 632 of concrete block 630 and module 600 is larger than the bottom of pan 610, and some or all of the sides of pan 610 or block 630 are flat but at an obtuse angle with the bottom of pan 610. Module 600 can otherwise be identical to module 150 and can be connected together using cables or bolts as described above. For installation on a flat surface as shown in FIG. 6B, two modules 600A and 600B can be placed with no gap at their top surfaces 632A and 632B. However, the angles of the adjoining sides provide space between the lower portions of modules 600A and 600B in the configuration of FIG. 6B. The change of slope as shown in FIG. 6C can decrease the separation between the lower portions of modules 600A and 600B.

Concrete modules with integrated pans as described are not limited to use in forming slabs but can be used in any area of concrete constructions.

FIG. 7 particularly illustrates one implementation of a curb and sidewalk 700 constructed using a curb module 710. Curb module 710 may be constructed in the same manner as module 150 described above and particularly includes an integrated pan 711, a concrete block 712, and passages 713. However, curb module 710 includes a road height side 714 and a taller sidewalk height side 715 and a concrete surface 716 finished in the desired shape of a curb. Road height side 714 may be the same height as that of a road module 720, and in particular, some passage 713 in curb module 710 may be aligned with passages in road module 720 for connection using bolts or cables as described above. As an alternative to passages 713 aligned with passages in road module 720, curb module 710 may include a termination fixture on side 714, so that a cable or bolt can be attached to side 714. Sidewalk side 715 may have a termination fixture 718 which is aligned for connection of a sidewalk module 730. For example, a bolt or cable through a passage in sidewalk module 730 may attach to and terminate at fixture 718 on side 715. Sidewalk module 730 may be the same as road module 720 and may particularly include an integrated pan such as described above for module 150. However, sidewalk module 730 may be different from road module 720, e.g., thinner, particularly if the load requirements of sidewalk module 725 differ from the load requirements of road module 720.

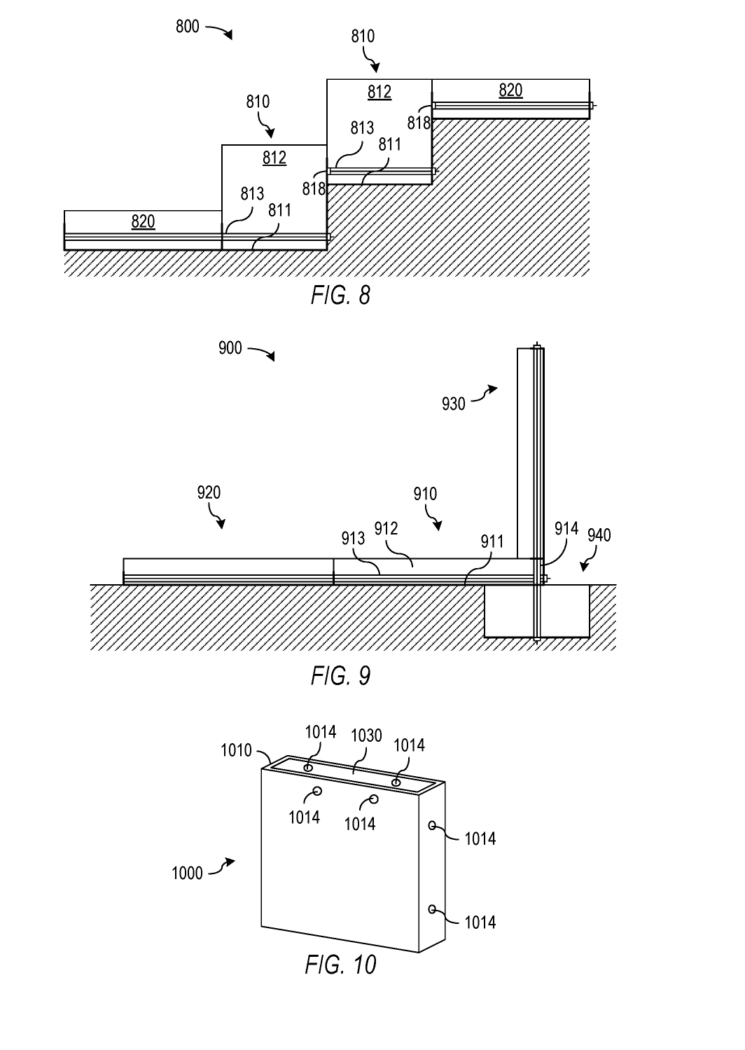

FIG. 8 illustrates one implementation of stairs 800 constructed using step modules 810. Each step module 810 includes an integrated pan 811, a concrete block 812, and one or more passages 813, which may be the similar or identical to structures described above with reference to module 150. Passages 813 may be used for connection via cables or bolts to a module 820, which may be part of a lower landing of stairs 800. Each step module 810 further includes an upper connection fixture 818 that may be used for connection to a next higher step 810 or a landing module 820. Fixture 818 may be any type of structure to which an adjacent module may connect. For example, fixture 818 be a threaded structure onto which a bolt through an adjacent module 810 or 820 can be tightened, or fixture 818 can be a termination structure for a cable that may pass through a passage in the next higher module 810 or 820.

FIG. 9 illustrates one implementation of structure 900 such a portion of a building or retaining wall constructed using a corner module 910. Corner module 910 includes an integrated pan 911, a concrete block 912, and one or more passages 913, which may be the similar or identical to structures described above with reference to module 150. Passages 913 may particularly be used for connection via cables or bolts to one or more horizontal floor modules 920. Passages 913 could alternatively be replaced with termination fixtures to which cables or bolts through floor modules 920 attach. Each corner module 910 further includes one or more passages 914 from the bottom of pan 911 to the top surface of module 910. In the specific implementation of FIG. 9, pan 911 extends up the entire length of one side of module 910 and onto the upper surface of module 914 in the area of passages 914. Passages 914 may be used for connection to one or more wall modules 930 using bolts or cables as described above. Wall module 920 may be substantially identical to floor module 920 and particularly include a pan bottom on one major surface and a finished concrete on the opposite major surface. Wall modules 930 would typically be vertical but may alternatively be at an angle with corner module 910, for example, where corner module 910 is part of a truss and module 930 is a diagonal or sloped module, e.g., for a roof structure. Optionally, to improve the stability of modules 910 and 930, a footing module 940 can be connected to modules 910, e.g., using passage 914.

FIG. 10 illustrates a module 1000 that includes a case 1010 that contains a block 1030, and case 1010 covers both major surfaces of block 1030. For example, case 1010 may enclose block 1030 and only be open on one end to permit pouring of a cement mixture such as concrete, other paving material, or filler material into case 1010 to form block. Case 1010 may otherwise include or enclose the same structures as described above with reference to pan 110. In particular, adhesion posts (not shown) may extend from one or more interior walls of case 1010 to improve adhesion of case 1010 to block 1030. Case 1010 may also contain reinforcing structures, e.g., rebar, which may be in block 1030 and attached to pan 1010. Case 1010 may also contain passages 1014 that extend between opposite sides of module 1000 and facilitate connecting of module 1000 to other modules using cables or bolts in the same manner as described above with reference to FIGS. 3A, 3B, 4A, 4B, or 9. Alternatively or additionally, case 1010 may be made of a metal such as steel or iron that allows welding, brazing, or similar metal joining techniques to attach module 1000 to other modules or to other metal surfaces or structures. The use of case 1010, which covers both major surfaces of module 1000, may eliminate the exposed/finished cement surface that some other module implementations provide, but case 1010 may improve the strength of module 1000 relative to modules using a pan that covers only one major surface of a block. Accordingly, modules such as module 1000 may provide the strength necessary for larger construction projects.

The modules described above may be modified to employ materials other than cement mixtures in blocks that attach to reinforcing pans. For example, in place of cement mixtures, other implementations may employ paving materials such as resins that adhere directly to the pans to provide a strong and attractive structure.

Although particular implementations have been disclosed, these implementations are only examples and should not be taken as limitations. Various adaptations and combinations of features of the implementations disclosed are within the scope of the following claims.

What is claimed is:

1. A module comprising:
a pan having a bottom that provides a bottom surface of the module; and
a block containing a cement mixture and attached to and overlying the pan to provide the module with a top surface having a cement finish.

2. The module of claim 1, wherein the bottom of the pan comprises a plurality of posts that extend up inside the block and increase adhesion of the pan to the block.

3. The module of claim 1, wherein the pan has one or more sides extending up from the bottom.

4. The module of claim 3, wherein the block extends directly above the sides of the pan.

5. The module of claim 3, wherein sides of the module each include a lower portion that is one of the sides of the pan and an upper portion that is part of a side of the block.

6. The module of claim 5, wherein:
a first side of the module is convex; and
a second side of the module is concave and complementary to the first side.

7. The module of claim 5, wherein the sides of the module form an obtuse angle with the bottom of the pan.

8. The module of claim 1, further comprising a passage extending through the module in a direction parallel to the bottom of the pan.

9. The module of claim 1, wherein the cement mixture of the block comprises concrete containing aggregate.

10. A structure comprising:
a first module that includes:
a first pan having a first bottom;
a first block containing a cement mixture attached to and overlying the first pan; and
a first passage through the first module and parallel to the first bottom;
a second module that includes:
a second pan having a bottom;
a second block containing a cement mixture attached to and overlying the second pan; and
a second passage through the second module; and
an attachment structure extending through the first and second passages and holding the first and second modules together.

11. The structure of claim 10, wherein the second passage is parallel to the second bottom.

12. The structure of claim 10, wherein the second passage is perpendicular to the second bottom.

13. The structure of claim 10, wherein the attachment structure includes a cable or a rod that extends continuously through the first and second passage.

14. The structure of claim 10, wherein the attachment structure comprises:
a first threaded structure that extends through the first passage; and
a second threaded structure that extends through the second passage and threads onto the first threaded structure.

15. A method for fabricating a module, comprising:
abutting forms adjacent to edges of a pan;
pouring a cement mixture into a volume defined by the pan and the forms;
finishing the cement mixture to create a top surface of the module; and
removing the forms to create a transportable module in which the pan is integrated and provides a bottom surface of the module.

16. The method of claim 15, wherein the pan has one or more sides extending up from the bottom surface provided by the pan, and wherein the forms extend to a height greater than the sides of the pan.

17. The method of claim 15, further comprising holding the forms abutted to the pan using an attachment to the pan.

18. The method of claim 15, further comprising holding the forms abutted to the pan using a structure that extends from a first of the forms to a second of the forms that is opposite the first form and though the volume into which the cement mixture is poured.

19. The method of claim 15, wherein the pan comprises posts that extend up inside the block and increase adhesion of the pan to the block.

20. The method of claim 15, wherein the cement mixture comprises concrete containing aggregate.
